(19) United States
(12) Patent Application Publication
(10) Pub. No.: US 2002/0026364 A1
(43) Pub. Date: Feb. 28, 2002

(54) Electronic waiter system

(76) Inventors: Tom Matthew Mayer, Oswego, IL (US); Robert John Grasch, Sandwich, IL (US)

Correspondence Address: Tom M. Mayer, 450 Gloria Lane, Oswego, IL, 60543, US

(21) Appl. No.: 09/827,034

(22) Filed: Apr. 5, 2001

Related U.S. Application Data
(60) Provisional application No. 60/195,271, filed on Apr. 7, 2000.

(51) Int. Cl. G06F 17/60

(52) U.S. Cl. 705/15

(57) ABSTRACT

The present invention is a method and system for interconnecting and streamlining the customer service and management functions of a restaurant. The system comprises a collection of handheld devices, software for operating the system, and a networking means such as a server intended to contain the information necessary for the operation of a restaurant's functions, including creation and maintenance of available menu items, inventory, customer seating, ordering, and billing.

### RELATED APPLICATIONS AND PATENTS

This application claims priority on Provisional Patent Application No. 60/195,271 filed Apr. 7, 2000 entitled Electronic Waiter System.

### FIELD OF THE INVENTION

The present invention is a system and method of use, comprising a collection of handheld devices, a networking means intended to contain the information necessary for the operation of a restaurant's functions, including creation and maintenance of available menu items, inventory, customer seating, ordering, and billing, software for operating the system, and a communication medium between these.

### BACKGROUND

The satisfactory operation of a restaurant or other food service operation involves a complex set of interactions between customers, hosts, wait staff, food preparers, and other restaurant personnel. These complex interactions must be accomplished promptly, efficiently, and accurately.

Traditionally, these interactions, such as the ordering process, have been accomplished manually, using handwritten order forms, checks, order boards, chalk boards, and the like. These written orders have then been interpreted by preparers and billed by cashiers. The affects of order preparation are later applied against inventory manually, with no ability to correlate to specific customers of wait staff.

With the advent of computers, efforts have been made to automate these interactions. Various aspects of billing and seating have been computerized. However, no system offers automation of the customer service functions while also automating the effects of customer service on restaurant management functions, such as wait staff and preparation staff efficiency and inventory maintenance.

For a typical example, a computer or other electronic display can be used to indicate empty tables or tables that are waiting for bus service. However, most restaurants use a graphic display and a grease pen. The present invention would allow reporting of the current status of each table and seated customer, whether reviewing the menus, having appetizers, the meal, dessert, after dinner drinks, or being bused.

Many restaurants even enter and maintain a table's orders at a wait station that is central to the tables or to groups of tables. The bill is tabulated at the end of service and the order is printed at the wait station and presented to the customers at the table. The present invention would eliminate the need for a separate wait station, and would thus allow for additional seating space. Additionally, it would eliminate the need for the wait staff to walk from the customers to the wait station to enter orders, allowing the wait staff more time to interact with the customers, speeding the order process, and reducing the risk of order errors.

Most store inventory is managed at day's end, when management tallies the day's usage and compares it to the last inventory amounts. This is done after reviewing the orders made for the period, the losses for the period, and the shortages discovered for the period. The present invention maintains a calculated usage of goods throughout the period, eliminating the need for this step in management's tally. This real-time inventory status also allows for the wait staff and kitchen staff to realize beforehand any outages of goods before an order is placed or before a potential meal is ruined.

### SUMMARY OF THE INVENTION

The present invention assists in the operation of a restaurant's management and customer service functions. The system of the present invention comprises at least one hand held device for inputting, outputting, and displaying information, a networking means, such as a server, for containing, displaying, and processing the information connected to said at least one hand held device, software for running said networking means such as a server and said at least one hand held device contained in said software or said at least one hand held device, and a connection means for connecting said at least one hand held device to said networking means such as a server.

The hand held devices can display an entire menu, including drinks, daily specials, and outages of items as contained, processed, and updated by the networking means such as a server. Basic menu items may be entered as a base of information, specials can be programmed daily onto the networking means such as a server, and outages of goods can be relayed from the networking means such as a server computer as they occur. The hand held devices also function as a display of the inventory of goods for the wait staff and potentially may be used to generate an order ticket for each table.

The present invention allows the wait staff to present the latest information available to the customers at the table, to take their exact order, to transmit the order to the kitchen for processing, to the bar for drinks, and to the networking means such as a server computer for a correct record, tally, and final billing of the meal and its resulting effect on inventory. The system provides instant menu access, correct pricing, correct meal ordering and preparation, and increased meal processing speed. Less time is wasted as the wait staff traverses the restaurant, which in turn increases the amount of time the wait staff is available to interact with customers. In addition, transmissions may be encrypted to make tampering with the process as difficult as possible, as well as preventing theft of service and goods.

### BRIEF DESCRIPTION OF THE DRAWINGS

The present invention will be better understood when viewing the following Figures:

FIG. 1 represents a schematic drawing of the system components and arrangement.

FIG. 2 represents one example of a process flow diagram of the present invention.

FIG. 3 represents the seating process of the present invention.

FIG. 4 represents the beverage ordering and processing portion of the present invention.

FIG. 5 represents the food ordering process of the present invention.

FIG. 6 represents a schematic drawing of the system components and arrangement of another embodiment of the present invention.

### DETAILED DESCRIPTION

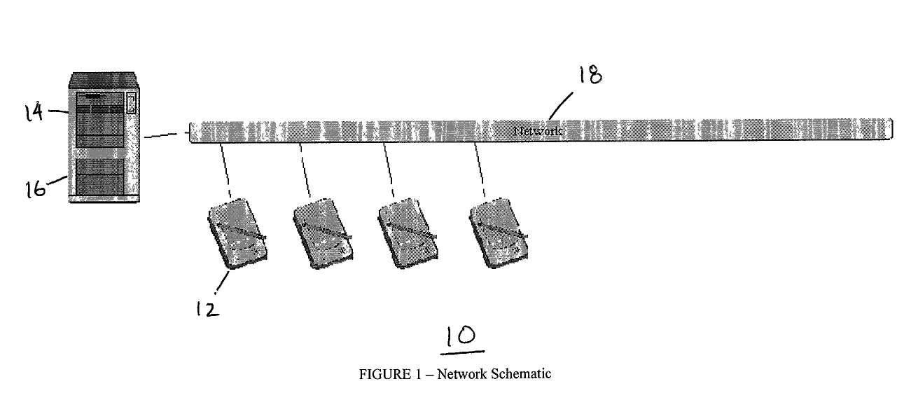

The present invention is a system for conducting and managing restaurant and customer service functions. The system 10 of the present invention, represented in FIG. 1, comprises at least one hand held device 12 for inputting, outputting, and displaying information, a networking means such as a server 14, usually a computer, for containing, displaying and processing the information connected to said at least one hand held device, software 16 for running said server and said at least one hand held device contained in said software or said at least one hand held device, and a connection means 18 for connecting said at least one hand held device to said networking means such as a server. The information, necessary for many of the operations of a restaurant's functions, includes information relating to the creation and maintenance of available menu items, inventory, customer seating, ordering, and billing.

The hand held device 12 is an input/output (I/O) type device and is preferably a mass produced computing device that is designed to be small and flexible, such as a manufactured palm computing device. Other examples of hand held devices include, but are not limited to, wireless data transmission devices, data exchange ports, credit card scanning devices, audible alert devices, and bill and/or receipt printers. These hand held devices are intended to be adaptable to changing restaurant needs as well as being expandable to allow growth of applications. The hand held device 12 is typically capable of no less than the ability to perform complex arithmetic, to store and retrieve data, and to recognize data entry and/or selection by either stylus tapping or writing.

The specific hand held device applications and components allow the hand held device 12 to interact with the networking means such as a server 14, typically a computer, and applications software 16 to facilitate the operations of a restaurant and make its operation more efficient. A hand held device's size allows for a person to carry the device easily. It can display text and graphics as needed to perform any of a number of tasks. The information to be displayed can be updated through direct physical connection and/or wireless data transfer, both of which makes the data capacity of the hand held devices much greater than a pre-printed form, and constantly accurate.

The hand held device 12 may be any network-capable device, such as Palm or Windows based. The specifics of the hand held device 12 is immaterial, provided that the hand held devices can interact with the appropriate software and communicate with the networking means such as a server. No particular manufacturer or vendor should be preferred. The hand held device 12 and networking means such as a server 14 programming contain the information necessary for the operation of a restaurant's entire menu, including drinks, daily specials, and availability of goods.

The wait staff I/O devices have touch screen input that allows the wait staff to input table assignment for customers that includes table and chair assignments, and have menu and drink order options so that orders can be taken by check mark input into the system. This check mark input requires only that an item be checked or selected for the order to be taken. As a result, the wait staff I/O will have menu and drink screens, as well as, optionally, an order confirmation screen that summarizes the orders taken.

The software 16 for the present invention comprises programming for the hand held device 12 and the computer networking means such as a server 14. It includes the capability to be revised, repaired, replaced, and/or added to in order to increase system functionality. Many current restaurants use common database software that is readily available and can be supplied with a networking means such as a server or purchased separately from software vendors or computer retailers. Examples include Oracle and SQL Server.

The server computer 14 contains the software programming 16 such as the master menu, daily specials, outages of goods as they occur, and the ability to control inventory of goods, track a customer's bill as it progresses, and ultimately produce an accurate bill at check-out. It also may include a floor plan and related database of tables and wait staff assignments which allows host(s) to seat people more quickly and easily while distributing the customers among the wait staff evenly. The system programming may further include encryption software so that the data sent between the hand held devices and the networking means such as a server system are less likely to be manipulated or taken.

The networking means software 16 may also maintain a record of sale of all goods, registering the items according to tax rate, and recording the appropriate amount and tax paid for ledger purposes. The networking means software 16 may also contain credit verification software to allow for credit card transactions.

The networking means is preferentially a server, such as a PC- or Macintosh-based system, as well as any other network operating system. The specific operating system of the networking means is immaterial, provided that the networking means 14 can interact with the appropriate software 16 and communicate with the at least one hand held device 12. No particular manufacturer or vendor is preferred.

A networking means 14 typically comprises of a computer and accompanying devices such as keyboard, mouse, and monitor. Additional devices, such as a printer or CD writing device may also be present to assist in the keeping of “hard copy” records. A network device must also be attached to the networking means such as a server by the connection medium so that the hand held devices can communicate freely with the networking means such as a server.

The connection medium for connecting the hand held device(s) to the networking means such as a server can be, but is not limited to, wireless mediums, such as infra-red transmissions or radio transmissions, or direct connection, wired docking stations and may be in the form of a network.

Network devices can be either wireless or wired. Wired network devices may be less practical than wireless devices due to distance restrictions and physical barriers, and will allow for data transfers from only specific locations inside the restaurant. Wireless devices may be less practical than wired devices due to radiation point interference and physical barriers, but will allow for data transfer from most locations inside the restaurant.

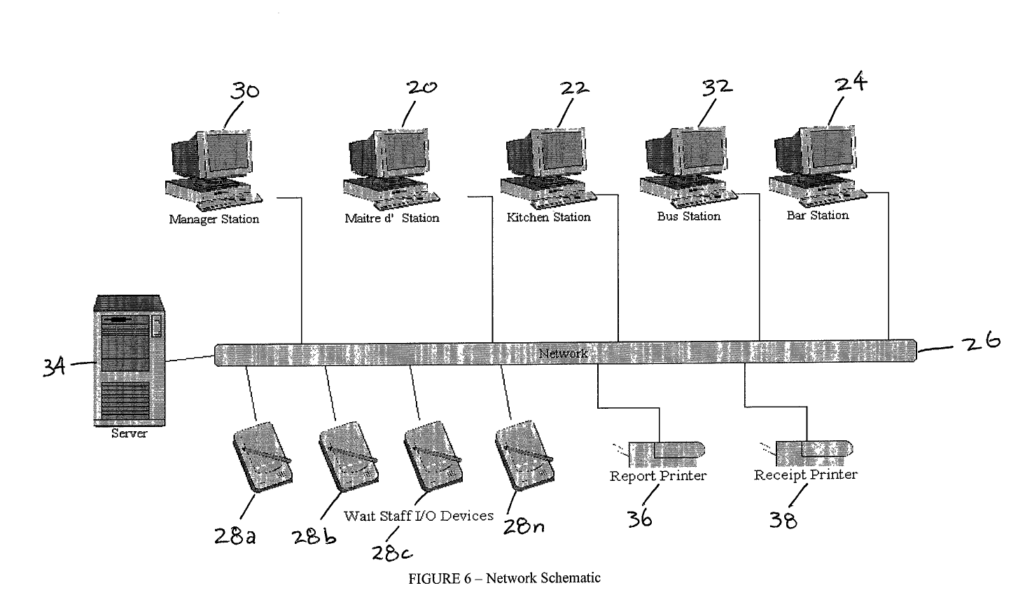

An alternative embodiment of the present invention is represented by FIG. 6. This alternate embodiment of the present invention comprises at least one Maitre d' station 20, at least one kitchen station 22, at least one bar station 24, at least one networking means 26 including a server 34 connected to said stations and device through said networking means, and at least one wait staff (I/O) device 28, wherein each station 20, 22, 24, and device 28 is connected together by said networking means 26 so that information is shared in real-time and personnel can access said information and conduct their duties within the restaurant. The system may also include a manager station 30, a bus station 32, report printer 36 and/or receipt printer 38. It is understood that the system may be networked completely through wireless means or may employ partially cabled portions connected with wireless portions. It will be preferred that the wait staff I/O devices 28a-n will be wireless, but systems that require such devices to be physically connected and synchronized to the network are also anticipated.

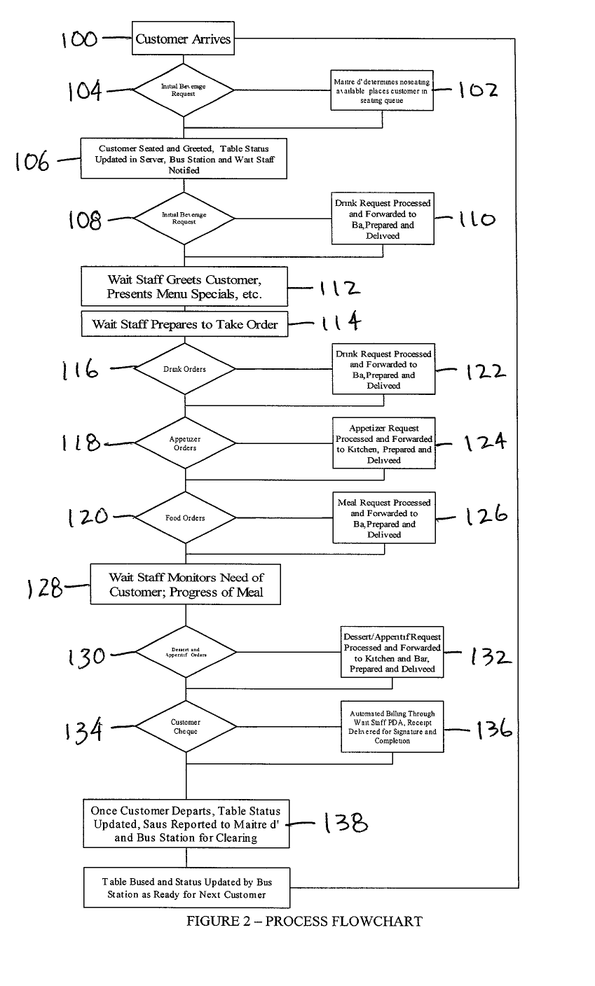

In use, the present invention allows for efficient management of customer service functions as illustrated in FIG. 2. A customer arrives at step 100. If seating is available, the customer is seated by the Maitre 'd and an initial beverage order is placed at step 102. If seating is not available, the customer remains in queue at step 104. Once the customer is seated and greeted at step 106, information is entered into the networking means such as a server via hand held device updating table status, bus station status and notifying the wait staff. Beverage requests are taken at step 108 and forwarded to the bar for filling and delivery at step 110. The wait staff then presents menu specials and information to the customer at step 112 and prepares to take the order at step 114. Drink, appetizer, and food orders are taken and entered into the hand held devices at steps 116, 118, and 120, respectively. The network forwards this information to the appropriate stations: to the bar at step 122, and to the kitchen station at steps 124 and 126. The stations prepare the order and notify the wait staff via the hand held devices and the wait staff delivers the order. The wait staff then monitors the progress of the meal at step 128. Additional orders for dessert or aperitif are taken, entered into the hand held device at step 130 and then transmitted to the appropriate station for preparation at step 132. The wait staff is again notified and delivers the order to the customer. Once the meal is completed, the stored information is accessed and a customer check is produced, either electronically or in printed form, at step 134. Payment may be received manually or a hand held device may be used to complete an electronic payment transaction at step 136. After the payment transaction is complete and the customer has left, the hand held devices are used to update the table status, need for busing, and impact of the orders on ingredient inventories at step 138. Upon completion of table busing, the process of the present invention begins over again at step 100.

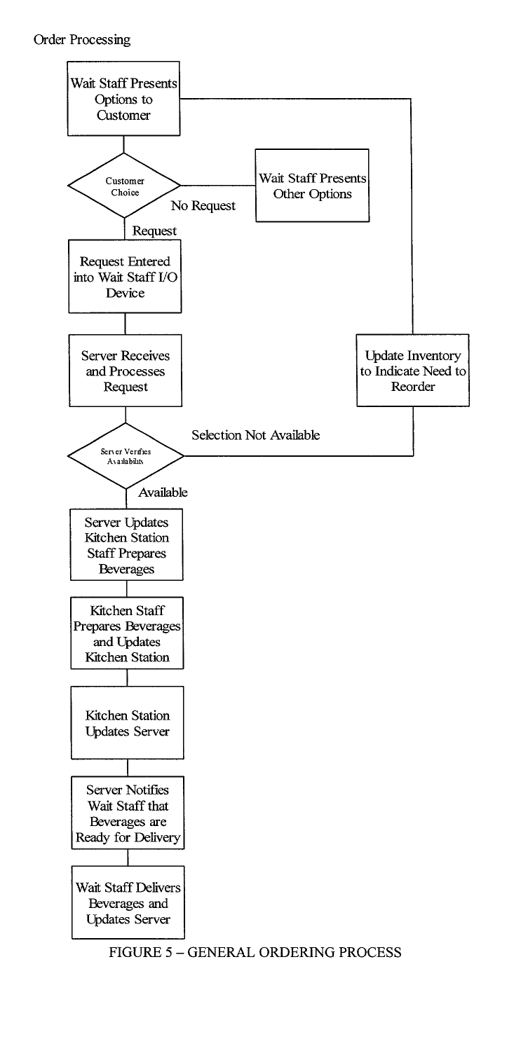

FIG. 5 illustrates the process of placing an order using a hand held device. Basic menu items may be entered as a base of information, specials can be programmed daily by download from the networking means such as a server, and outages of goods can be relayed from the networking means such as a server computer as they occur. Each item on the order can be checked for availability of goods, recorded with specific information such as the brand of liquor in a drink or the absence of an ingredient in a meal, and the accurate order can be placed immediately. The accurate order can be presented to the kitchen and bar staff, as appropriate, so that the order can be filled according to specifics, reducing the chances of error.

Pertinent ingredients taken for each order can be automatically deducted from the standing calculated inventory. As an order is filled, a notification can be made that alerts the initiating hand held device that the order is ready for retrieval. At the termination of the service, the bill may be paid at the table with a credit card by simply entering the credit card information into the hand held device, which relays the information to the networking means such as a server system, which in turn verifies the information. If approval is made, the networking means such as a server system can notify the initiating hand held device that approval is made, and the customer using the credit card can then sign the hand held device with a stylus. The signature can then be transmitted to the networking means such as a server for record.

Also at the termination of service, the networking means such as a server system can notify the seating staff that the table will be vacant, and a calculated time for clearing and resetting the table can be shown for table availability. The tally of all tables and all tables available may notify the seating staff or Maitre 'd which tables are available, allowing the wait staff to be utilized efficiently.

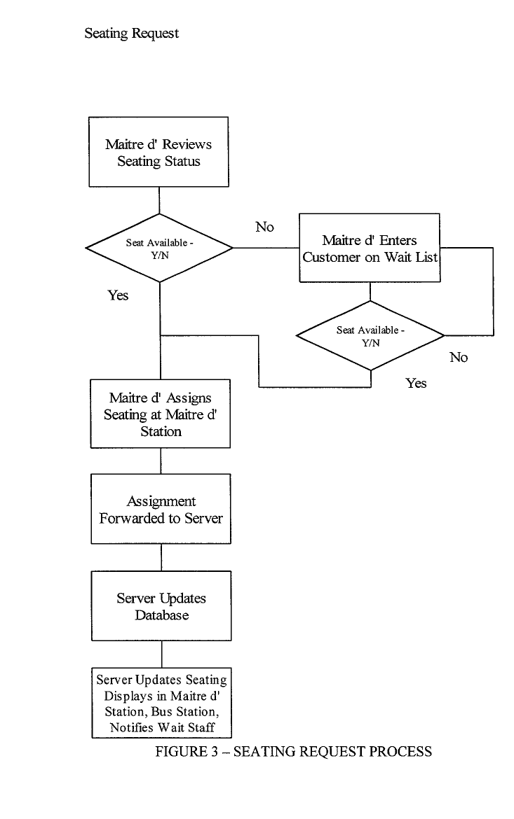

FIG. 3 illustrates further detail of the seating request process from step 102 in FIG. 2. Using a hand held device or the Maitre 'd station, the Maitre 'd checks the seating status of the restaurant tables. If all seats and tables are full, the customer is wait listed in the database via the hand held device or station. If seating is available, the customer is seated and the Maitre 'd updates the information in the system. The seating information is forwarded in the system to the proper wait staff or other appropriate station, again through screen display on the hand held devices.

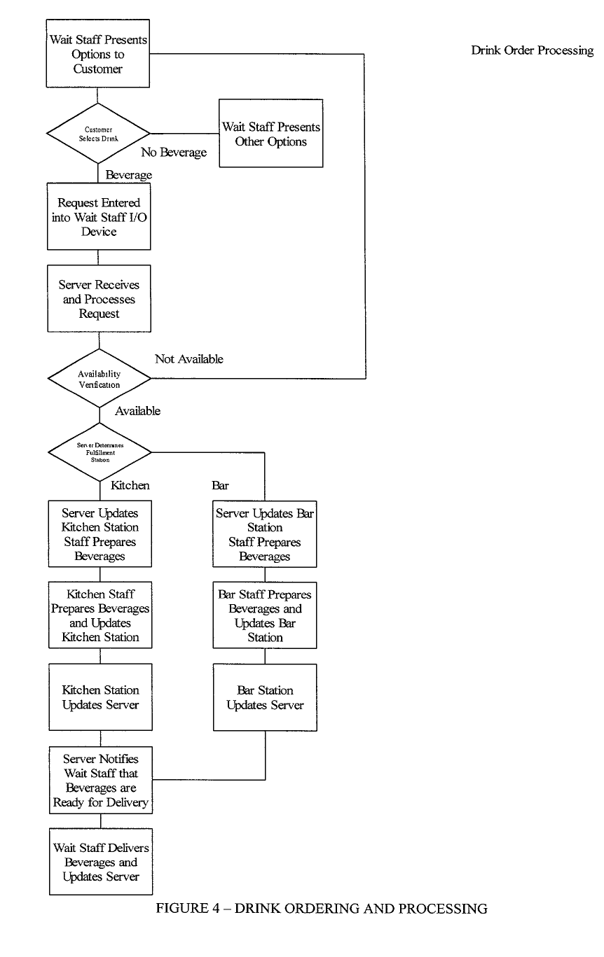

FIG. 4 illustrates further detail of the drink ordering process from steps 108 and 110 in FIG. 2. The wait staff presents the customer with a beverage request, based on availability information displayed in a hand held ordering device. Upon customer selection, the wait staff enters the request or order in the hand held device. The order is transmitted through the networking means such as a server to other appropriate stations or devices resulting in preparation of the beverage by the kitchen or bar. Once prepared, the kitchen or bar station is updated and the status is transmitted to the wait staff who then delivers the order to the customer. The networking system may also automatically update the restaurant inventory and client billing status.

While I have described and illustrated several embodiments of my invention herein, it will be understood that these are by way of illustration only and that various changes and modifications may be contemplated within my invention and are within the scope of the following claims, including the use of such a system in an environment other than a restaurant, utilizing the same underlying features, methods, and/or claims embodied in this submission, unless that use is protected by prior patent or use.

1. A system for restaurant and customer service functions comprising:
at least one hand held device for inputting, outputting, and displaying restaurant and customer service information;
a networking means for containing and processing said information connected to said at least one hand held device;
software for running said networking means and said at least one hand held device contained in said software and said at least one hand held device; and
a connection means for connecting said at least one hand held device to said networking means.

2. A method for facilitating interconnection of restaurant customer service and restaurant management comprising the steps of:
Storing restaurant and customer service information;
Updating said restaurant and customer service information; and
Informing restaurant staff and management of said restaurant and customer service information.

3. A system for restaurant and customer service functions comprising:
at least one Maitre d' station;
at least one kitchen station;
at least one bar station;
at least one networking means; and
at least one wait staff input/output (I/O) device, wherein each said at least one Maitre 'd station, said at least one kitchen station, said at least one bar station and said at least one wait staff input/output (I/O) device is networked by said networking means so that at least one restaurant and customer service information is shared in real-time and personnel can access said information and conduct their duties within the restaurant.

4. The system of claim 3 further comprising:
at least one manager station;
at least one bus station; and
at least one printer.

5. The system of claim 3 wherein said networking means is a server.

6. The system of claim 3 wherein said networking means is wireless.

7. The system of claim 3 wherein said networking means employs partially cabled portions connected with wireless portions.
